(19) United States
(12) Patent Application Publication
(10) Pub. No.: US 2026/0074180 A1
(43) Pub. Date: Mar. 12, 2026

(54) FEEDING SYSTEM AND DRY ELECTRODE MANUFACTURING SYSTEM INCLUDING THE SAME

(71) Applicants: Hyundai Motor Company, Seoul (KR); Kia Corporation, Seoul (KR)

(72) Inventor: Hyun Jin Kim, Hwaseong (KR)

(21) Appl. No.: 19/232,229

(22) Filed: Jun. 9, 2025

(30) Foreign Application Priority Data
Sep. 11, 2024 (KR) 10-2024-0123587

(51) Int. Cl. H01M 4/04

(52) U.S. Cl. CPC H01M 4/0435

(57) ABSTRACT

A feeding system and method are disclosed for manufacturing a dry electrode. The system includes a roll press that forms a dry electrode mixture into a film, a feeder that delivers the mixture, and a flattener that continuously levels it on the roll press. The feeder may include a first feeder with trays to supply measured amounts, a hopper, a second feeder to facilitate discharge, and an optional third feeder to maintain fluidity. A level sensor detects the mixture height, enabling a controller to stop or resume feeding and prevent over-accumulation. The method involves rotating the roll press, supplying the mixture, flattening it, and adjusting feed based on sensor readings. A battery incorporating the dry electrode produced by this process is also described.

### CROSS-REFERENCE TO RELATED APPLICATION

This application claims, under 35 U.S.C. § 119(a), the benefit of Korean Patent Application No. 10-2024-0123587, filed on Sep. 11, 2024, the entire contents of which are incorporated herein by reference.

### BACKGROUND

### Technical Field

The present disclosure relates to a dry electrode and, more particularly, to manufacturing of a dry electrode.

### Background

Recently, a rechargeable secondary battery is expanding its application in various fields from a small electronic device to a large energy storage system. Particularly, with the rapid growth of the electric vehicle market, research and development on the secondary battery is being actively conducted.

The electrode of the secondary battery has been generally manufactured through a wet process. In the wet process, an electrode active material, a binder, and a conductive additive included in the electrode are dissolved in a solvent to prepare a slurry. However, in recent years, a dry process performed without using a solvent which is needed in the wet process and capable of increasing the energy density of a battery compared to the wet process is receiving a great attention.

In the dry process of manufacturing an electrode, an electrode active material, a conductive additive, and a binder are mixed without a solvent to form a mixture, and then the mixture is formed into a dry electrode film using a press or calendering method. Then the dry electrode film is attached to a current collector, completing the manufacture of the electrode.

Compared to the wet process, the dry process may reduce the manufacturing time and cost because a solvent is not used in the process and may adjust the thickness of film, obtaining a dry electrode film having a high energy density.

Despite the advantages, the dry electrode manufacturing technology is still in the early stage of development, and there are still many technical challenges to be solved for the widespread use of the dry electrode. For example, the design of a feeding system that takes into account the characteristics of the material of the dry electrode is needed.

The above information disclosed in this Background section is only for enhancement of understanding of the background of the present disclosure, and therefore it may contain information that does not form the prior art that is already known to one having ordinary skill in the art.

### SUMMARY OF THE DISCLOSURE

The present disclosure has been made in an effort to solve the above-described problems associated with the existing technologies, and some embodiments provide a feeding system capable of speeding up the manufacturing of a dry electrode and a dry electrode manufacturing system including the same.

Some embodiments of the present disclosure provide a feeding system capable of securing the quality of a dry electrode and a dry electrode manufacturing system including the same.

According to some forms of the present disclosure, a dry electrode mixture feeding system includes a roll press, a feeder configured to supply a dry electrode mixture to the roll press, and a flattener configured to continuously flatten the dry electrode mixture placed on the roll press.

According to some forms of the present disclosure, a dry electrode manufacturing system includes the dry electrode mixture feeding system.

According to some forms of the present disclosure, a method for manufacturing a dry electrode includes rotating a roll press, supplying, by a feeder, a dry electrode mixture to the roll press, and flattening, by a flattener, the dry electrode mixture placed on the roll press.

According to some forms of the present disclosure, a battery includes a dry electrode manufactured by the method.

In some embodiments, a feeding system comprises a roll press configured to form a dry electrode mixture into a film, a feeder configured to supply the dry electrode mixture to the roll press, and a flattener configured to continuously flatten the dry electrode mixture placed on the roll press. The flattener may be configured to move in a lengthwise direction of the roll press. The feeder may comprise a first feeder configured to discretely supply a predetermined amount of dry electrode mixture to the roll press. The first feeder may comprise a transfer portion configured to convey a plurality of trays, each tray accommodating a predetermined amount of the dry electrode mixture, and a controller configured to adjust the transfer portion based on a detected height of the dry electrode mixture on the roll press. A level sensor may be provided to detect the height of the dry electrode mixture placed on the roll press, and the controller may stop or resume operation of the first feeder based on a comparison between the detected height and a predetermined threshold. Based on the detected height being a first height reaching a line extending from a top point of the roll press, the controller may stop the first feeder from supplying the dry electrode mixture to the roll press. Based on the detected height reaching a second height smaller than the first height the controller may resume operation of the first feeder. The feeder further may comprise a second feeder. The second feeder may accommodate the dry electrode mixture and may supply the dry electrode mixture to the first feeder. The feeder may further comprise a third feeder arranged between the first feeder and the second feeder, configured to provide fluidity to the dry electrode mixture supplied from the first feeder, and the third feeder may also comprise any one selected from a circle feeder, a screw feeder, or a rotary feeder. The roll press may comprise a pair of rollers configured to press the dry electrode mixture into a continuous dry electrode film. The dry electrode mixture may comprise at least one electrode active material, a conductive material, and a binder in the absence of a solvent. A dry electrode manufacturing system may comprise the feeding system.

In some embodiments, a method for manufacturing a dry electrode comprises rotating a roll press configured to form a dry electrode mixture into a film, supplying, via a feeder, the dry electrode mixture to the roll press, and flattening, by a flattener, the dry electrode mixture placed on the roll press. The method may further comprise detecting, by a level sensor, a height of the dry electrode mixture on the roll press and controlling an operation of the feeder based on the detected height. The method may include stopping the feeder when the detected height of the dry electrode mixture reaches a line extending from a top point of the roll press and resuming the operation of the feeder when the detected height of the dry electrode mixture drops to a predetermined height that remains below the flattener. The feeder may comprise a first feeder configured to discretely supply a predetermined amount of dry electrode mixture to the roll press. The feeder may further comprise a second feeder configured to accommodate therein the dry electrode mixture mixed by a mixer and a third feeder configured to discharge the dry electrode mixture to the first feeder while rotating the dry electrode mixture supplied from the second feeder.

In some embodiments, a battery comprises the dry electrode manufactured by the method.

As discussed, the method and system suitably include use of a controller or processer.

In another embodiment, vehicles are provided that comprise an apparatus as disclosed herein.

Other aspects and preferred embodiments of the present disclosure are discussed infra.

The above and other features of the present disclosure are discussed infra.

### BRIEF DESCRIPTION OF THE DRAWINGS

The above and other features of the present disclosure will now be described in detail with reference to certain embodiments thereof illustrated in the accompanying drawings which are given herein below by way of illustration only, and thus are not limitative of the present disclosure, and wherein:

FIG. 1 schematically illustrates a process of manufacturing a dry electrode;

FIG. 2 schematically illustrates a feeding system and a roll press according to some embodiments of the present disclosure;

FIG. 3 is a front view of a feeding system according to some embodiments of the present disclosure;

FIG. 4 is a plan view of a feeding system according to some embodiments of the present disclosure;

FIG. 5 illustrates the arrangement of a transfer feeder and a roll press in a feeding system according to some embodiments of the present disclosure;

FIG. 6 is a plan view of a feeding system according to some embodiments of the present disclosure;

FIG. 7 illustrates a tray of a transfer feeder viewed from V1 in FIG. 6;

FIG. 8 illustrates an auxiliary feeder and a transfer feeder according to some embodiments of the present disclosure;

FIG. 9 illustrates a relationship between a flattener and a roll press in a feeding system according to some embodiments of the present disclosure; and

FIG. 10 is an operation flow chart for a feeding system according to some embodiments of the present disclosure.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

The term “dry electrode mixture” used herein refers to a composition of electrode materials—such as an electrode active material, a conductive additive, and a binder—formulated without using a liquid solvent. The mixture typically remains in a powdered or semi-powdered state before being compressed into a film.

The term “roll press” used herein refers to a mechanical device comprising at least one pair of rotating rollers configured to compress or shape a material fed between them into a continuous film. Roll presses are widely used in battery manufacturing to form electrodes from dry mixtures.

The term “feeder” used herein refers to any apparatus or collection of apparatuses (e.g., hoppers, rotary feeders, transfer conveyors) that delivers material from a storage container or mixer to a downstream process, such as a roll press.

The term “flattener” used herein refers to a movable component arranged above the roll press and configured to level or distribute a bulk material on the roller surface, promoting a uniform thickness before the material is pressed or calendered.

The term “level sensor” used herein refers to a sensing device (such as a radar sensor or other appropriate sensor type) that detects the height or depth of material present in a specified region, allowing control systems to maintain optimal feeding conditions.

The term “first feeder” used herein refers to a specific portion of the overall feeder system configured to discretely supply a predetermined amount of the dry electrode mixture, typically through trays or other volume-based dispensing mechanisms, to the roll press.

The term “second feeder” used herein refers to a portion of the feeding system that receives the dry electrode mixture and discretely or continuously supplies the predetermined amount of the dry electrode mixture to a feeder, e.g., the first feeder or a third feeder..

The term “third feeder” used herein refers to a portion of the feeding system positioned between the first feeder and the second feeder, which imparts motion—such as rotational or vibrational motion—to facilitate material flow or prevent clogging, bridging, or ratholing.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between”, “adjacent” versus “directly adjacent”, etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

Hereinafter, the present disclosure is described in detail with reference to the accompanying drawings.

A dry electrode may be prepared from a dry electrode mixture and a current collector, without a solvent. A dry electrode mixture M comprises an electrode active material, a conductive material (a conductive additive or a conducting agent), and a binder. Moreover, the dry electrode mixture M may further comprise an additive.

The dry electrode may be a cathode or an anode. In some embodiments, when the cathode is prepared, the electrode active material comprises a cathode active material. As a non-limiting example, the cathode active material may be LCO(LiCoO2), NCM(Li(Ni,Co, Mn)O2), NCA(Li(Ni,Co,Al)O2, LMO(LiMnO4), LFP(LiFePO4), or sulfur.

In some embodiments, when the anode is prepared, the electrode active material comprises an anode active material. For example, the anode active material may be natural graphite, artificial graphite, mesocarbon microbeads (MCMB), or silicon series.

The conductive additive may be a carbon-based material. For example, the conductive additive may be carbon black, acetylene black, carbon fiber, or carbon nanotube.

The binder may be polyvinylidene fluoride (PVDF), polytetrafluoroethylene (PTFE), or a copolymer comprising the same.

As the additive, a solid polymer electrolyte, such as a polyethylene oxide (PEO), or an oxide-based or sulfide-based solid electrolyte component may be partly used.

In one embodiment, the dry electrode mixture may contain 70 to 99.9% by weight of the electrode active material, 0.1 to 20% by weight of the conductive material, and 0.1 to 20% by weight of the binder. Here, 0 to 20% by weight of the additive may be added.

In one embodiment, the dry electrode may be an electrode for a secondary battery.

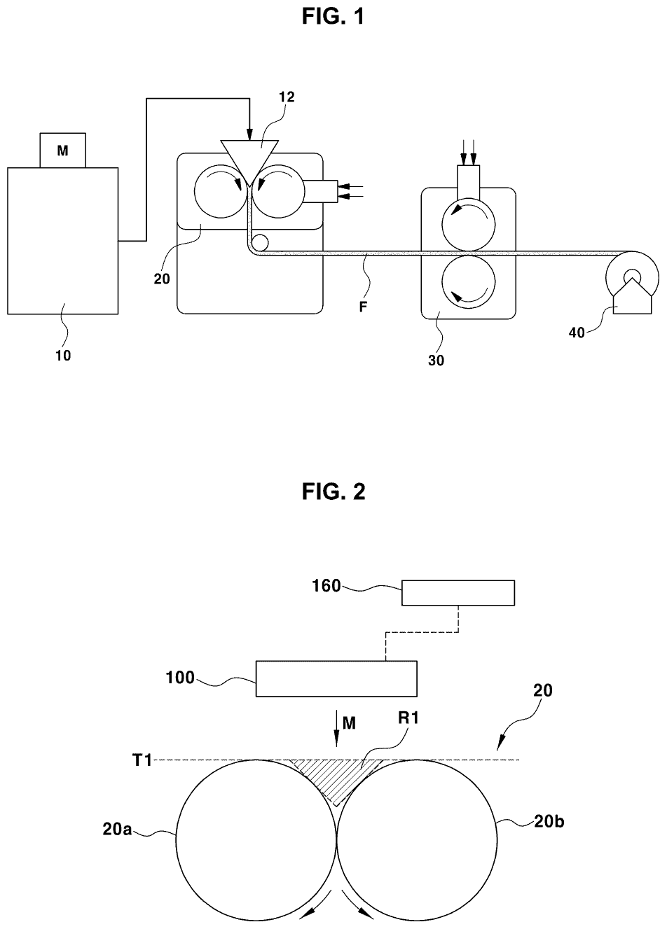

As illustrated in FIG. 1, the dry electrode mixture M is formed into a dry electrode film F through a series of film forming processes in which heat and pressure are applied. First, the dry electrode mixture M comprising the electrode active material, the conductive material, and the binder is mixed by a mixer 10 for and at a predetermined time and speed. As a non-limiting example, the dry electrode mixture may be prepared by a high shear mixer using rotation or by a fluid mixer using air. The predetermined time and speed may be adjusted by changing the rotation speed and operation time of the mixer 10.

Here, the dry electrode mixture M is powder in a state in which the electrode active material, the conductive material, and the binder are properly mixed and dispersed by the mixer 10 so as to be formed into a film when pressed by a film forming apparatus, i.e., a roll press 20. The dry electrode mixture M may be said to be properly mixed and dispersed through fiberization of the binder and complexation of the conductive material.

The dry electrode mixture M mixed in the mixer 10 may be formed into a film by the film forming apparatus. Specifically, the dry electrode mixture M mixed in the mixer 10 may be directed to a feeder 12 or to the roll press 20. The dry electrode mixture M may first be pressed into a film in an upstream roll press 20. The upstream roll press 20 rotates while providing a pressing force to form the dry electrode mixture M into a film. The dry electrode mixture M first formed into a film may further be pressed in a downstream roll press 30, and the thickness of the dry electrode mixture M may be adjusted through pressing. The dry electrode film F, which is the dry electrode mixture formed into a film, is then wound by a winder 40. Thereafter, the dry electrode film F is attached or laminated to a current collector to manufacture a dry electrode.

Partly due to the high cohesiveness and large angle of repose of the dry electrode mixture M, a feeding technology for the dry electrode mixture M plays a very important role in the manufacturing of a dry electrode. When feeding the dry electrode mixture M, a simple feeding method may cause damage to the roll press, and various problems may occur, such as a difference in density, which may cause tearing or inconsistent thickness of a manufactured dry electrode film.

To solve said problems, a feeding system to control the flow of the dry electrode mixture M supplied to the roll press 20 is being designed. However, the feeding system uses a method of shaking the dry electrode mixture M so that the dry electrode mixture M falls in particles into the roll press 20, which requires a dust collector resulting in loss of raw materials during the operation and makes it difficult to speed up the manufacturing of a dry electrode.

For this reason, the present disclosure provides a feeding system, capable of securing the quality of a dry electrode and speeding up the manufacturing of the dry electrode without the above-mentioned problems, and a dry electrode manufacturing system including the same. A feeding system 100 may be arranged at the position of the feeder 12 in FIG. 1.

Referring to FIG. 2, the roll press 20, which is a film forming apparatus, includes a pair of rollers 20a and 20b. The rollers 20a and 20b may form a dry electrode mixture M supplied from the feeding system 100 into a film by applying heat or pressure, or both, while rotating. Particularly, the rollers 20a and 20b may press the dry electrode mixture M supplied to a region R1 defined by the rollers 20a and 20b.

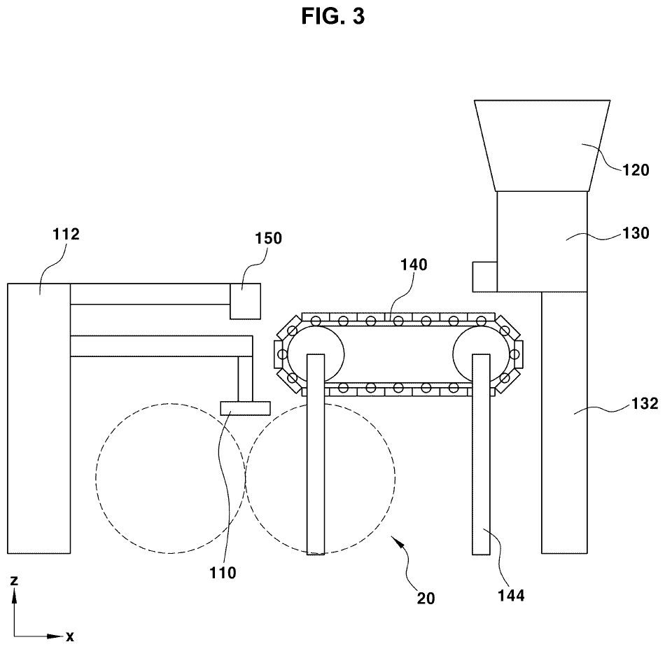

As illustrated in FIG. 3, the feeding system 100 may supply a dry electrode mixture to the roll press 20. According to some embodiments of the present disclosure, the feeding system 100 includes a flattener 110. The flattener 110 may flatten a dry electrode mixture M placed on the roll press 20. Particularly, the flattener 110 may flatten the dry electrode mixture M supplied to the region R1. The operation of the flattener 110 enables a continuous process without affecting the quality of the dry electrode mixture M. The meaning of “continuous process” may be that a film may be continuously formed by preventing an excessive amount of dry electrode mixture M from being sucked into the roll press 20 for a short period of time during the operation of the roll press 20. When the roll press 20 is operated while the dry electrode mixture M is being accumulated in the region R1, an excessive amount of the dry electrode mixture (especially, a cathode dry electrode mixture) is sucked into the roll press 20 due to the characteristics of the dry electrode mixture M. This causes tearing or inconsistent thickness of the manufactured film as mentioned above. The present disclosure may solve the problem by using the flattener 110, and thus the dry electrode film F may be continuously manufactured without interruption.

The flattener 110 may be suspended above the roll press 20. In one embodiment, the flattener 110 may be hung above the roll press 20 by a support frame 112.

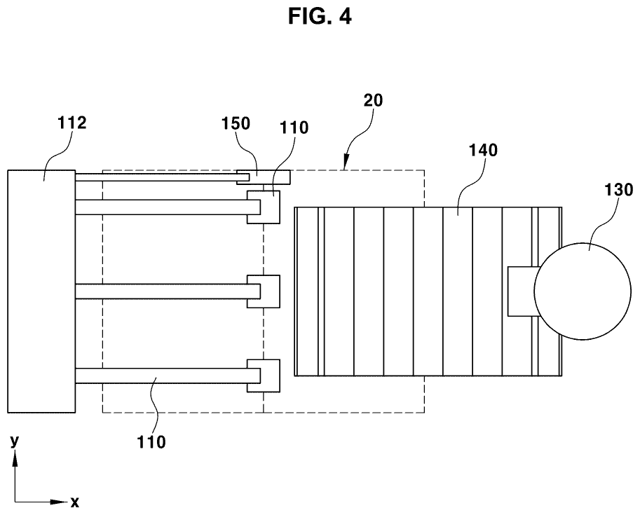

Referring to FIG. 4, the flattener 110 may be configured to be movable. While the dry electrode mixture M is supplied to the region R1, the flattener 110 may continuously move in a lengthwise direction (y-axis direction) and flatten the dry electrode mixture M accumulated in the region R1. In one example, the flattener 110 may move with respect to the support frame 112. Specifically, the flattener 110 may move in the longitudinal direction (y) of the roll press 20. In one example, the flattener 110 is movable with respect to the support frame 112 by a linear transfer machine, such as a linear motor. As in the illustrated embodiment, the flattener 110 may include a plurality of flatteners that are separated from each other. In another embodiment, there may be provided one flattener 110. In still another embodiment, the flattener 110 may have a single body, but may have a longer length.

The feeding system 100 may include a plurality of feeders 120, 130, and 140. The feeders 120, 130, and 140 may supply the dry electrode mixture M to the roll press 20. The feeders 120, 130, and 140 may prevent a bridging phenomenon or ratholing, which occurs due to the characteristics of the dry electrode mixture, while speeding up the manufacturing of the dry electrode.

According to one embodiment, the plurality of feeders 120, 130, and 140 may include a hopper 120. The hopper 120 may be supplied with the dry electrode mixture M mixed by the mixer 10. In one example, the dry electrode mixture M from the mixer 10 may be delivered to the hopper 120 through vacuuming.

According to one embodiment, the plurality of feeders 120, 130, and 140 may include an auxiliary feeder 130. The auxiliary feeder 130 may include a rotatable blade to apply a rotational force to the dry electrode mixture M supplied from the hopper 120 so as to facilitate discharge of the dry electrode mixture M. Moreover, the auxiliary feeder 130 may prevent ratholing or bridging in the dry electrode mixture M within the hopper 120. As a non-limiting example, the auxiliary feeder 130 may be a circle feeder. As another non-limiting example, the auxiliary feeder 130 may be a rotary feeder. As still another non-limiting example, the auxiliary feeder 130 may be a screw feeder. However, the auxiliary feeder 130 is not limited thereto, and any feeder configured to facilitate discharge of the dry electrode mixture M within the hopper 120 may be used.

In one embodiment, the hopper 120 and the auxiliary feeder 130 may be directly connected to each other. The dry electrode mixture M in the hopper 120 may be directly moved to the auxiliary feeder 130. In one example, the hopper 120 and the auxiliary feeder 130 may be connected to each other, and the hopper 120 and the auxiliary feeder 130 connected to each other may be supported by a support structure 132.

According to one embodiment, the plurality of feeders 120, 130, and 140 may include a transfer feeder 140. The transfer feeder 140 may deliver the dry electrode mixture M, discharged from the hopper 120 or from the auxiliary feeder 130, toward the roll press 20. For this purpose, in one example, the transfer feeder 140 may include a transfer portion 142. As a non-limiting example, the transfer portion 142 may be a conveyor.

For example, when the hopper 120 or the auxiliary feeder 130 transfer the dry electrode mixture M in a gravitational direction (−z-axis direction), the transfer feeder 140 may transfer the dry electrode mixture M in a generally horizontal direction (x-axis direction). In the illustrated embodiment, the transfer feeder 140 is illustrated as transferring the dry electrode mixture M in only the horizontal direction (x-axis direction). However, the transfer feeder 140 may be inclined with respect to the horizontal direction (x-axis direction) to convert the flow of the dry electrode mixture M in the gravitational direction (z) into a flow in the horizontal direction (x-axis direction).

The transfer feeder 140 may finally deliver the dry electrode mixture M to the roll press 20 in the gravitational direction (z). The transfer feeder 140 may be arranged above the roll press 20 and below the hopper 120 or the auxiliary feeder 130 in the gravitational direction (z). For example, the transfer feeder 140 may be supported by a mounting frame 144 and may be arranged at a lower vertical position than the hopper 120 or the auxiliary feeder 130 by the mounting frame 144. The dry electrode mixture M discharged from the hopper 120 or the auxiliary feeder 130 may fall onto the transfer feeder 140.

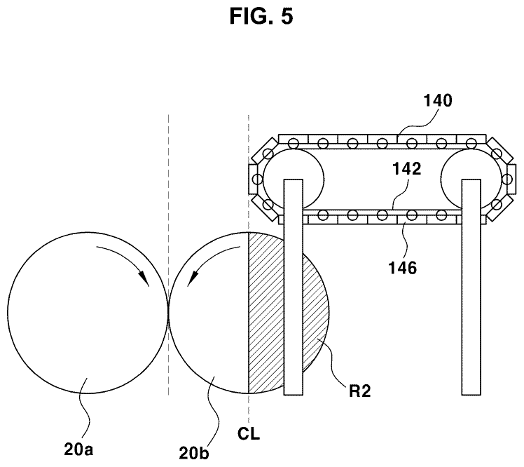

In one embodiment, as illustrated in FIG. 5, in a relationship between the roll press 20 and the transfer feeder 140, it is preferable that the transfer feeder 140 is arranged in an outer radius region R2 of the roller 20b with respect to the center line CL of the roller 20b that is adjacent to the transfer feeder 140.

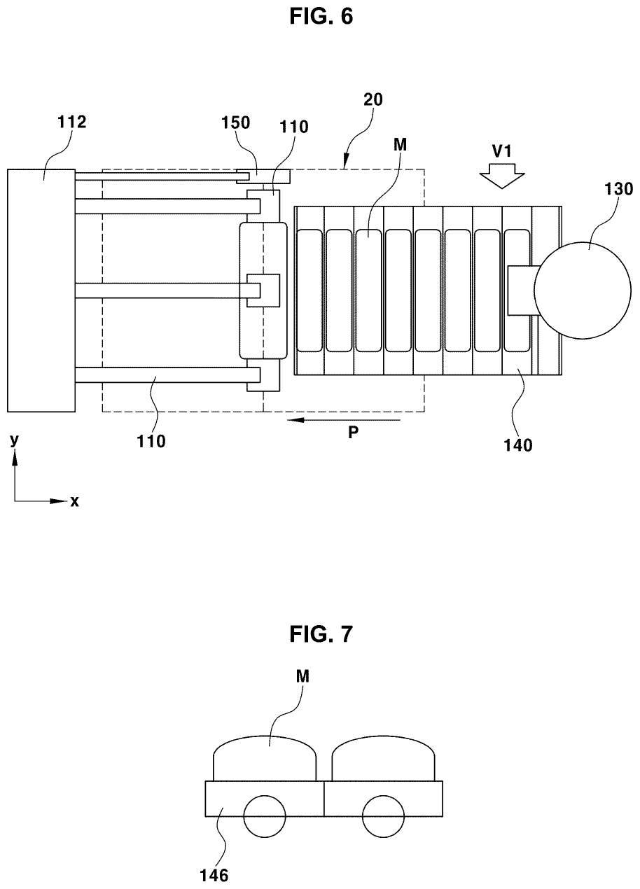

Referring to FIGS. 6 and 7, the transfer feeder 140 may be supplied with the dry electrode mixture M from the hopper 120 or the auxiliary feeder 130 and deliver the dry electrode mixture M to the roll press 20. In FIG. 6, “P” denotes a transfer direction of the dry electrode mixture M. In one embodiment, the transfer feeder 140 may be supplied with and accommodate therein the dry electrode mixture M discretely. To this end, according to one embodiment, the transfer feeder 140 may include a plurality of trays 146 configured to be connectable to each other. Each tray 146 is configured to be mounted on the transfer portion 142 and to accommodate therein a predetermined amount of dry electrode mixture M. Therefore, a dry electrode mixture M accommodated in one tray 146 may be separated from a dry electrode mixture M accommodated in another tray 146.

According to the present disclosure, because the transfer feeder 140 is arranged lower than the hopper 120 or the auxiliary feeder 130 in the gravitational direction (z), the dry electrode mixture M may be supplied to the roll press 20 with a small potential energy. Moreover, because the dry electrode mixture M is supplied to the press 20 in a predetermined volume or in bulk by separating and placing a predetermined amount of dry electrode mixture M in the trays 146, dust may be minimized, preventing loss of raw materials owing to use of a dust collector. Furthermore, according to the present disclosure, because a bulk amount of dry electrode mixture M is supplied to the roll press 20 without using a method of scattering the dry electrode mixture M, a large amount of dry electrode mixture M may be supplied to the roll press 20 per hour compared to using a conventional method, thereby greatly increasing the process speed.

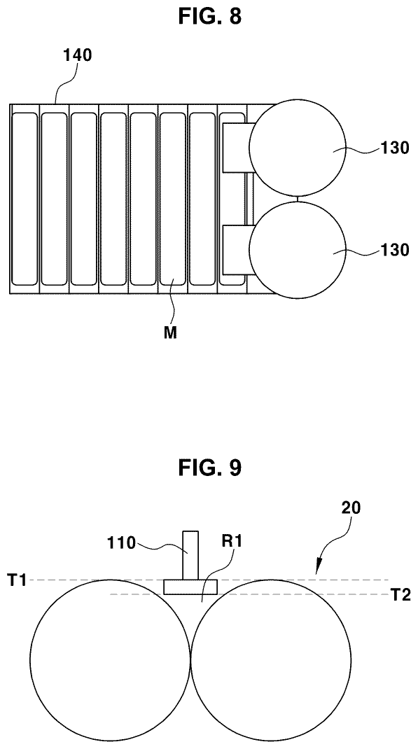

In one example, one or more auxiliary feeders 130 may be arranged. As illustrated in FIG. 8, two or more auxiliary feeders 130 may be arranged to supply the dry electrode mixture M to one tray 146 of the transfer feeder 140. By doing so, the supply amount of the dry electrode mixture M may be increased, further increasing the process speed.

The feeding system 100 may further include a level sensor 150. In one embodiment, the level sensor 150 may be mounted on the support frame 112 and arranged above and beside the roll press 20.

The level sensor 150 may detect the height of the dry electrode mixture M piled in the region R1. As a non-limiting example, the level sensor 150 may be a radar sensor. A radar sensor may be useful as not being interfered with by plastic materials. However, the type of the level sensor 150 is not limited thereto, and other known types of sensors may be used.

Referring to FIG. 9, the level sensor 150 may detect a height T1 of the dry electrode mixture M in the region R1. The height T1 may be a tangent line that touches the top points of the rollers 20a and 20b. Moreover, the level sensor 150 may detect a height T2 of the dry electrode mixture M. The height T2 may be a predetermined height of the dry electrode mixture M in which the dry electrode mixture M in the region R1 does not reach the flattener 110.

The feeding system 100 may further include a controller 160. The controller 160 may control the operation of the feeding system 100.

In one embodiment, the controller 160 is configured to control the rotation of the transfer feeder 140. The controller 160 may control the rotating operation and stoppage of the rotation of the transfer feeder 140 to control the amount of dry electrode mixture M fed into the roll press 20.

In one embodiment, the controller 160 is configured to communicate with the level sensor 150. When the level sensor 150 detects that the dry electrode mixture M reaches the height T1, the controller 160 may stop the rotating operation of the transfer feeder 140. It was confirmed that it is difficult to perform the continuous process when the dry electrode mixture M accumulates above the height T1 in the region R1. According to the present disclosure, it is possible to perform the continuous process by preventing the dry electrode mixture M from accumulating above the height T1 in the region R1. Moreover, it was confirmed that it is possible to perform the continuous process by a cooperative operation with the flattener 110. Therefore, when the height of the dry electrode mixture M in the region R1 does not reach the flattener 110, the controller 160 may operate the transfer feeder 140 so that the dry electrode mixture M is supplied to the roll press 20.

The operation of the feeding system 100 according to some embodiments of the present disclosure is as follows.

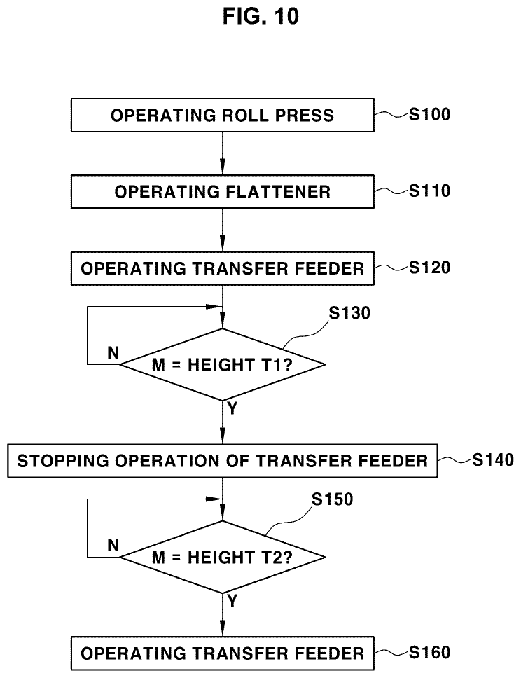

Referring to FIG. 10, at operation S100, the roll press 20 is operated to form the dry electrode mixture M into a film. Moreover, during the rotation of the roll press 20, the flattener 110 is configured to flatten the dry electrode mixture M in the region R1 while continuously moving in the lengthwise direction (y-axis direction), at operation S110.

To form the dry electrode mixture M into a film, the dry electrode mixture M is supplied to the tray 146 of the transfer feeder 140 through the hopper 120 or the auxiliary feeder 130. The controller 160 may control the transfer feeder 140 to rotate so that the dry electrode mixture M in each of the trays 146 is sequentially supplied to the roll press 20, at operation S120.

The level sensor 150 is configured to detect the height of the dry electrode mixture M in the region R1. First, the level sensor 150 detects whether the dry electrode mixture M reaches the height T1, at operation S130. When the level sensor 150 detects that the dry electrode mixture M reaches the height T1, the controller 160 stops the operation of the transfer feeder 140, at operation S140. Meanwhile, the roll press 20 rotates, and the flattener 110 also performs a flattening operation.

The level sensor 150 is configured to continuously detect the height of the dry electrode mixture M in the region R1. The level sensor 150 may determine whether the dry electrode mixture M reaches the height T2, at operation S150. When the level sensor 150 detects that the dry electrode mixture M reaches the height T2, the controller 160 activates the transfer feeder 140, at operation S160. Therefore, according to the present disclosure, the amount of the dry electrode mixture M on the roll press 20 may be continuously adjusted while the film forming process is continuously performed without interruption.

By repeating the series of operations, a dry electrode manufacturing system may manufacture a dry electrode.

According to some forms of the present disclosure, the dry electrode manufacturing system includes the feeding system 100.

According to some forms of the present disclosure, a battery may be manufactured by the dry electrode manufacturing system.

The feeding system herein is described as being used in the process of forming a dry electrode mixture into a film. However, the feeding system may also be used in the process of forming other powder-type film.

As is apparent from the above description, the present disclosure provides the following effects.

According to the present disclosure, a feeding system capable of speeding up the manufacturing of a dry electrode and a dry electrode manufacturing system including the same are provided.

According to the present disclosure, a feeding system capable of securing the quality of a dry electrode and a dry electrode manufacturing system including the same are provided.

Effects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A feeding system comprising:
a roll press configured to form a dry electrode mixture into a film;
a feeder configured to supply the dry electrode mixture to the roll press; and
a flattener configured to flatten the dry electrode mixture placed on the roll press.

2. The feeding system of claim 1, wherein the flattener is configured to move in a lengthwise direction of the roll press.

3. The feeding system of claim 1, wherein the feeder comprises a first feeder configured to discretely supply a predetermined amount of dry electrode mixture to the roll press.

4. The feeding system of claim 3, wherein the first feeder comprises:
a transfer portion configured to convey a plurality of trays, each tray accommodating a predetermined amount of the dry electrode mixture, and
a controller configured to adjust the transfer portion based on a detected height of the dry electrode mixture on the roll press.

5. The feeding system of claim 4, further comprising a level sensor configured to detect the height of the dry electrode mixture placed on the roll press, and the controller stops or resumes operation of the first feeder based on a comparison between the detected height and a predetermined threshold.

6. The feeding system of claim 4, wherein, based on the detected height being a first height reaching a line extending from a top point of the roll press, the controller is configured to stop the first feeder from supplying the dry electrode mixture to the roll press

7. The feeding system of claim 4, wherein, based on the detected height reaching a second height smaller than the first height the controller is configured to resume operation of the first feeder.

8. The feeding system of claim 3, wherein the feeder further comprises
a second feeder, and
wherein the second feeder accommodates the dry electrode mixture and is configured to supply the dry electrode mixture to the first feeder.

9. The feeding system of claim 8, wherein the feeder further comprises a third feeder, and
wherein the third feeder is arranged between the first feeder and the second feeder and is configured to provide fluidity to the dry electrode mixture supplied from the first feeder.

10. The feeding system of claim 9, wherein the third feeder comprises any one selected from a circle feeder, a screw feeder, or a rotary feeder.

11. The feeding system of claim 1, wherein the roll press comprises a pair of rollers configured to press the dry electrode mixture into a continuous dry electrode film.

12. The feeding system of claim 1, wherein the dry electrode mixture comprises at least one electrode active material, a conductive material, and a binder in the absence of a solvent.

13. A dry electrode manufacturing system comprising the feeding system of claim 1.

14. A method for manufacturing a dry electrode, the method comprising:
rotating a roll press configured to form a dry electrode mixture into a film;
supplying, via a feeder, the dry electrode mixture to the roll press; and
flattening, by a flattener, the dry electrode mixture placed on the roll press.

15. The method of claim 14, further comprising:
detecting, by a level sensor, a height of a dry electrode mixture placed on the roll press; and
controlling an operation of the feeder based on the detected height.

16. The method of claim 15, comprising:
stopping the feeder when the detected height of the dry electrode mixture reaches a line extending from a top point of the roll press.

17. The method of claim 16, further comprising:
resuming the operation of the feeder the detected height of the dry electrode mixture drops to a predetermined height that remains below the flattener.

18. The method of claim 14, wherein the feeder comprises a first feeder configured to discretely supply a predetermined amount of dry electrode mixture to the roll press.

19. The method of claim 18, wherein the feeder further comprises:
a second feeder configured to accommodate therein the dry electrode mixture mixed by a mixer; and
a third feeder configured to discharge the dry electrode mixture to the first feeder while rotating the dry electrode mixture supplied from the second feeder.

20. A battery comprising the dry electrode manufactured by the method of claim 14.
